(19) United States
(12) Patent Application Publication
(10) Pub. No.: US 2019/0054849 A1
(43) Pub. Date: Feb. 21, 2019

(54) VEHICLE MAINTENANCE METHOD USING MOBILE VEHICLE MAINTENANCE STATION

(71) Applicant: Feng YAN, Shenzhen (CN)

(72) Inventor: Feng YAN, Shenzhen (CN)

(21) Appl. No.: 16/162,809

(22) Filed: Oct. 17, 2018

Related U.S. Application Data
(63) Continuation-in-part of application No. PCT/CN2017/071438, filed on Jan. 17, 2017.

(30) Foreign Application Priority Data
Feb. 17, 2016 (CN) 201610089413.0
May 10, 2016 (CN) 201620415608.5
May 13, 2016 (CN) 201610318945.7
May 13, 2016 (CN) 201620437565.0
May 30, 2016 (CN) 201610370861.8

(51) Int. Cl. B60P 3/14; B66F 3/28; B60S 5/00

(52) U.S. Cl. CPC B60P 3/14; B60S 5/00; B66F 3/28

(57) ABSTRACT

A vehicle maintenance method using a mobile vehicle maintenance station, includes: determining a location of a vehicle to be maintained; and a technician taking the maintenance station to the location of the vehicle to be maintained and using the maintenance station to perform corresponding maintenance operations on the vehicle to be maintained. The maintenance operations include: taking a lifting mechanism out of a compartment of the maintenance station, and supporting the lifting mechanism on the ground; moving the vehicle to be maintained to the lifting mechanism and fixing the same thereto; and raising the vehicle to be maintained to a predetermined height by using the lifting mechanism so that an overhead space is formed between a chassis of the vehicle to be maintained and the ground, and the technician entering the overhead space to perform maintenance operations on the chassis of the vehicle to be maintained.

### CROSS-REFERENCE TO RELATED APPLICATIONS

This application is a continuation-in-part of International Application No. PCT/CN2017/071438 filed Jan. 17, 2017 which designated the U.S., and claims priority to Chinese Application Nos. CN201610089413.0, filed Feb. 17, 2016, CN201620415608.5, filed May 10, 2016, CN201610318945.7, filed May 13, 2016, CN201620437565.0, filed May 13, 2016 and CN201610370861.8, filed May 30, 2016, the entire contents of each of which are incorporated by reference.

### TECHNICAL FIELD

The present application relates to the field of vehicle maintenance technology, and in particular to a vehicle maintenance method using a mobile vehicle maintenance station.

### BACKGROUND

With the progress of society and the rapid development of the economy, vehicles have become the main means of transportation for people. As a consumable, the performance of the vehicle will decrease as time goes by, and it will look older as well. Therefore, people pay great attention to the maintenance of the vehicles while using the vehicle a lot.

Traditionally, the vehicle maintenance is carried out by the owner himself or the owner actively contacts the maintenance personnel to drive the vehicle to a special maintenance site for maintenance and repair. This traditional vehicle maintenance mode is not convenient, especially for the owner, it is a great waste of time.

### SUMMARY

In order to solve the above technical problem, the technical solution of the present application is to provide a vehicle maintenance method using a mobile vehicle maintenance station, including the following steps of:

determining the location of a vehicle to be maintained;

carrying the mobile vehicle maintenance station to the location of the vehicle to be maintained and using the mobile vehicle maintenance station to perform corresponding maintenance operations on the vehicle to be maintained;

wherein during the maintenance operations the vehicle to be maintained is raised by using a lifting mechanism of the mobile vehicle maintenance station and the corresponding maintenance operations are performed, and the maintenance operations include the following steps of:

taking the lifting mechanism out of a compartment of the mobile vehicle maintenance station and supporting the lifting mechanism on the ground;

moving the vehicle to be maintained on the lifting mechanism and fixing the same thereto; and

raising the vehicle to be maintained to a predetermined height by using the lifting mechanism so that an overhead space for the maintenance operations is formed between a chassis of the vehicle to be maintained and the ground, which allows the entering of a working technician for operation.

Optionally, the mobile vehicle maintenance station comprises a mobile unfolding device fixedly installed in the compartment, a driving end of the mobile unfolding device is connected with the lifting mechanism, during the maintenance operations taking the lifting mechanism out of the compartment of the mobile vehicle maintenance station is by using the mobile unfolding device taking the lifting mechanism out of the compartment and lowering the lifting mechanism from the height of the floor of the compartment to the ground.

Optionally, the mobile vehicle maintenance station further comprises a tire maintenance equipment installed in the compartment, and the maintenance operations further comprise the step of: by using the tire maintenance equipment performing maintenance operations on a tire of the vehicle to be maintained.

Optionally, the tire maintenance equipment comprises a tire demounting device and a tire dynamic balance detecting device respectively installed in the compartment, the maintenance operations further include the step of: by using the tire demounting device performing a tire demounting operation of a wheel removed from the vehicle to be maintained so as to perform tire repair or tire replacement, and by using the tire dynamic balance detecting device performing dynamic balance detection and maintenance of the wheel after completion of the tire repair or the tire replacement.

Optionally, the lifting mechanism comprises a base, a lifting drive device and a lifting plate, the base is connected with the driving end of the mobile unfolding device, one end of the lifting drive device is connected to the base, the other end of the lifting drive device is connected with the lifting plate, the base is placed on the ground for providing support, and the vehicle to be maintained is moved on the lifting plate and fixed, and during the process of raising the vehicle to be maintained to the predetermined height by using the lifting mechanism, the lifting plate is driven by the lifting drive device to be raised so as to form an overhead space for the maintenance operations between the chassis of the vehicle to be maintained and the ground.

Optionally, the mobile vehicle maintenance station further comprises a control device disposed in the compartment, the mobile unfolding device and the lifting drive device are both electrically connected with the control device, both the mobile unfolding device and the lifting drive device are hydraulic drive machines, the mobile vehicle maintenance station further comprises a hydraulic oil cylinder, and the control device controls the mobile unfolding device and the lifting drive device to uniformly supply the hydraulic oil from the hydraulic oil cylinder to generate hydraulic power.

Optionally, the mobile vehicle maintenance station further comprises a protection device disposed between the base and the lifting drive device, the protection device is electrically connected with the control device; during the process of raising the vehicle to be maintained to the predetermined height by using the lifting mechanism so as to form an overhead space for the maintenance operations between the chassis of the vehicle to be maintained and the ground, after the lifting drive device raises the lifting plate the protection device automatically implements protection function to prevent the lifting drive device from falling due to pressure relief, and during the process of controlling the lifting drive device to release pressure to lower the lifting plate the control device controls the protection function of the protection device to be disabled.

Optionally, the protection device comprises a fixed protection portion, a snap-fit protection portion and a jack-up portion, the fixed protection portion is fixedly disposed on the base, the snap-fit protection portion is movably connected to the lifting drive device, and the jack-up portion is disposed on the snap-fit protection portion; during the process of raising the vehicle to be maintained to the predetermined height by using the lifting mechanism so as to form an overhead space for the maintenance operations between the chassis of the vehicle to be maintained and the ground, after the lifting drive device raises the lifting plate, the snap-fit protection portion and the fixed protection portion automatically cooperate to implement the protection function to prevent the lifting drive device from falling due to pressure relief, and during the process in which the control device controls the lifting drive device to release pressure to lower the lifting plate, a driving end of the jack-up portion pushes up the snap-fit protection portion to disable the protection function formed between the snap-fit protection portion and the fixed protection portion.

Optionally, the jack-up portion is a pneumatic machine, the mobile maintenance station further comprises an air pump, the air pump and the pneumatic machine are connected through an air pipeline to pump the air, air pressure is supplied to the pneumatic machine so that a driving end of the pneumatic machine pushes up the snap-fit protection portion, the air pump is electrically connected with the control device, and the control device controls the operation of the air pump to supply air pressure to the pneumatic machine.

Optionally, the mobile vehicle protection station further comprises a separate power source disposed in the compartment to provide required power during the maintenance operations.

In the present application, by adopting a mobile vehicle maintenance station, maintenance operations of a portable mobile solution is performed on a vehicle to be maintained, thereby changing a mode in which the maintenance of the vehicle must be performed at a designated maintenance store in the prior art. When the vehicle needs to be maintained, the vehicle maintenance station follows the location of the vehicle to carry out the follow-up convenient maintenance service of a portable vehicle maintenance mode, which provides sufficient convenience for the vehicle owner and reduces the valuable time of the vehicle owner to be wasted.

### BRIEF DESCRIPTION OF DRAWINGS

FIG. 1 is a top plan schematic structural view of a first embodiment of a mobile vehicle maintenance station of the present application;

FIG. 2 is a side schematic structural view of a first embodiment of a mobile vehicle maintenance station of the present application;

FIG. 3 is a side schematic structural view of a first embodiment of a mobile vehicle maintenance station of the present application when a vehicle lifting device is unfolded;

FIG. 4 is a perspective schematic structural view of a vehicle lifting device and related driving components of a first embodiment of a mobile vehicle maintenance station of the present application;

FIG. 5 is a front schematic view of the structure in FIG. 4;

FIG. 6 is a schematic view of the structure in FIG. 4, after being unfolded;

FIG. 7 is a front perspective schematic structural view of the mechanical protection structure of a first embodiment of a mobile vehicle maintenance station of the present application;

FIG. 8 is a left side view of FIG. 7;

FIG. 9 is a schematic structural view of a lifting mechanism of a second embodiment of a mobile vehicle maintenance station of the present application;

FIG. 10 is a schematic perspective structural view of a lifting mechanism of a second embodiment of a mobile vehicle maintenance station of the present application, after being unfolded;

FIG. 11 shows a mobile vehicle maintenance station according to another embodiment of the present application when a vehicle lifting device is unfolded;

FIG. 12 shows the lifting mechanism according to another embodiment of the present application;

FIG. 13 shows the lifting mechanism according to another embodiment of the present application; and

FIG. 14 is a top plan schematic structural view of another embodiment of a mobile vehicle maintenance station of the present application.

In the drawings:

| | |
|---|---|
| 10 [symbol] Compartment; | 20 [symbol] Lifting Mechanism; |
| 21 [symbol] Base; | 22 [symbol] First Lift Arm; |
| 23 [symbol] Second Lift Arm; | 24 [symbol] Lifting Plate; |
| 25 [symbol] Hydraulic Drive Member; | 30 [symbol] Protection Device; |
| 31 [symbol] Fixed Protection Portion; | 32 [symbol] Snap-fit Protection Portion; |
| 33 [symbol] Jack-up Portion; | 41 [symbol] First Hydraulic Oil Cylinder; |
| 42 [symbol] Second Hydraulic Oil Cylinder; | 43 [symbol] horizontal storage protection |
| | sensor; |
| 44 [symbol] Third Hydraulic Oil Cylinder; | 51 [symbol] Tire Demounting Machine; |
| 52 [symbol] Tire Dynamic Balance | 53 [symbol] Air Pump; |
| Machine; | |
| 54 [symbol] power generating device; | 321 [symbol] Hinge Shaft; |
| 322 [symbol] Snap-fit Lever; | 411 [symbol] First Guide Sleeve; |
| 412 [symbol] First Guide Shaft; | 421 [symbol] Second Guide Sleeve; |
| 422 [symbol] Second Guide Shaft. | |

### DETAILED DESCRIPTION

In order to make the object, technical solutions and advantages of the present application more clear, the present application will be further described in detail below with reference to the accompanying drawings and embodiments. It should be understood that the specific embodiments described herein are merely illustrative of the application and are not intended to limit the present application.

It should be noted that when an element is referred to as being “fixed” or “set” to another element, it may be directly on said another element or indirectly on said another element. When an element is referred to as being “connected” to another element, it may be directly connected to said another element or indirectly connected to said another element.

It should also be noted that the orientation terms such as left, right, upper and lower in the embodiments are merely relative concepts or reference to the normal use state of the product, and should not be considered as limiting.

In the technical solution provided by the present application, a vehicle maintenance method using a mobile vehicle maintenance station is provided, which includes the following steps:

determining the location of a vehicle to be maintained;

carrying the mobile vehicle maintenance station to the location of the vehicle to be maintained and using the mobile vehicle maintenance station to perform corresponding maintenance operations on the vehicle to be maintained;

wherein during the maintenance operations the vehicle to be maintained is raised by using a lifting mechanism 20 of the mobile vehicle maintenance station and the corresponding maintenance operations are performed, and the maintenance operations include the following steps of:

taking the lifting mechanism 20 out of a compartment 10 of the mobile vehicle maintenance station and supporting the lifting mechanism 20 on the ground;

moving the vehicle to be maintained on the lifting mechanism 20 and fixing the same thereto; and

raising the vehicle to be maintained to a predetermined height by using the lifting mechanism 20 so that an overhead space for the maintenance operations is formed between a chassis of the vehicle to be maintained and the ground, which allows the entering of a working technician for operation.

By adopting a mobile vehicle maintenance station provided by the present application, maintenance operations of a portable mobile solution is performed on a vehicle to be maintained, thereby changing a mode in which the maintenance of the vehicle must be performed at a designated maintenance store in the prior art. When the vehicle needs to be maintained, the vehicle maintenance station follows the location of the vehicle to carry out the follow-up convenient maintenance service of a portable vehicle maintenance mode, which provides sufficient convenience for the vehicle owner and reduces the valuable time of the vehicle owner to be wasted.

The mobile vehicle protection station includes a separate power source that is disposed within the cabin 10 to provide all of the required electrical energy during the maintenance operations.

In the present application, the mobile vehicle maintenance station employed includes a mobile unfolding device that is fixedly mounted in the compartment 10, and a driving end of the mobile unfolding device is connected with the lifting mechanism 20, the lifting mechanism is taken out of the compartment 10 by using mobile unfolding device the and lowered from the height of the floor of the compartment 10 to the ground.

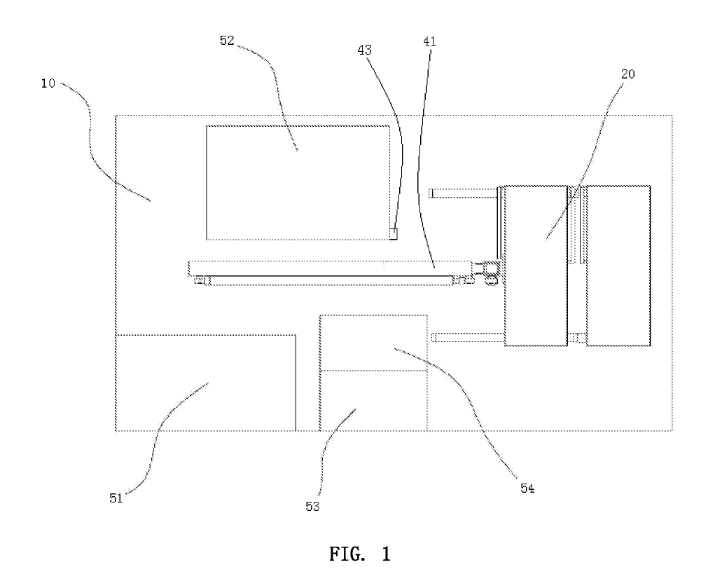

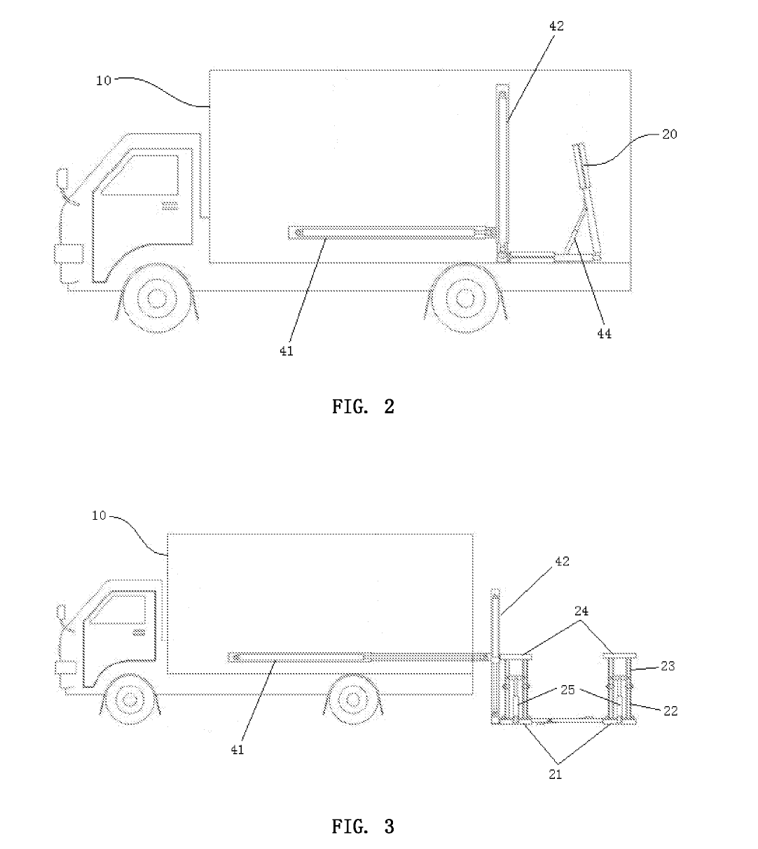

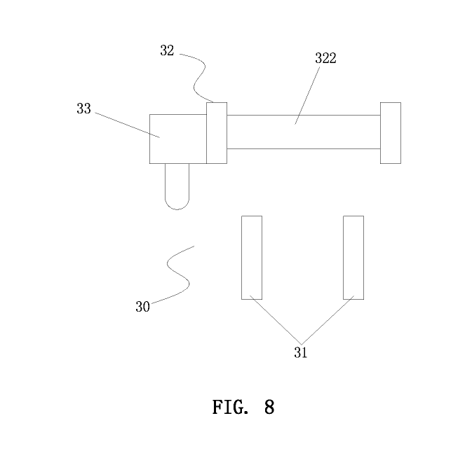

As shown in FIGS. 1 to 8, which show schematic structural views of a first embodiment of the present application. The mobile unfolding device includes a first hydraulic oil cylinder 41, a second hydraulic oil cylinder 42 and a third hydraulic oil cylinder 44, the first hydraulic oil cylinder 41 is horizontally disposed on the floor of the compartment 10, the pivot end of the first hydraulic oil cylinder 41 and the compartment 10 are fixedly connected with each other, the driving end of the first hydraulic oil cylinder 41 is connected to the second hydraulic oil cylinder 42, and the extending direction of the driving rod of the first hydraulic oil cylinder 41 is perpendicular to the extending direction of the driving rod of the second hydraulic oil cylinder 42. In this embodiment, the lifting mechanism 20 has two lifting portions juxtaposed to each other, and the two lifting portions can be folded relative to each other for storage. As shown in FIG. 2, the third hydraulic oil cylinder 44 is connected between the two lifting portions to realize a folding storage manner. After the first hydraulic oil cylinder 41 and the second hydraulic oil cylinder 42 lower the lifting mechanism 20 onto the ground, as shown in FIGS. 3 to 6, the third hydraulic oil cylinder 44 is used to flatten the two lifting portions on the ground so as to raise the vehicle to be maintained, which has been fixed, off the ground to form an overhead space.

In the first embodiment, each lifting portion of the lifting mechanism 20 includes a base 21, a lifting drive device, and a lifting plate 24. The base 21 is connected with the driving end of the second hydraulic oil cylinder 42 of the mobile unfolding device, and the third hydraulic oil cylinder 44 is connected between the two bases 21. The lifting drive device comprises a first lift arm 22, a second lift arm 23 and a hydraulic drive member 25, the first lift arm 22 and the second lift arm 23 are hingedly connected to each other to form an X-shaped cross structure. One ends of the first lift arm 22 and the second lift arm 23 are connected to the base 21, the other ends of the first lift arm 22 and the second lift arm 23 are connected to the lifting plate 24, one end of the hydraulic drive member 25 is fixed on the base, and the other end of the hydraulic drive member 25 is drivingly connected to the first lift arm 22 (or the other end of the hydraulic drive member 25 is drivingly connected to the second lift arm 23, in this embodiment the other end of the hydraulic drive member 25 is drivingly connected to the first lift arm 22 as an example). The base 21 is lowered onto the ground for providing support, the vehicle to be maintained is moved on the lifting plate 24 and fixed, and the lifting plate 24 is driven by the lifting drive device to be raised to form an overhead space for maintenance operations between the chassis of the vehicle to be maintained and the ground. After the lifting mechanism 20 is unfolded on the ground by using the first hydraulic oil cylinder 41, the second hydraulic oil cylinder 42, and the third hydraulic oil cylinder 44, the base 21 is stably placed on the ground and the vehicle to be moved is moved on the lifting plate 24, and then the hydraulic drive member 25 is activated to drive the first lift arm 22 to move, thereby causing relative movement between the first lift arm 22 and the second lift arm 23, which raises the lifting plate 24, thereby raising the vehicle to be maintained from the ground to form the overhead space.

In the process of taking the lifting mechanism 20 out of the compartment 10 by using the first hydraulic oil cylinder 41 and the second hydraulic oil cylinder 42, in order to ensure the working strength of the first hydraulic oil cylinder 41 and the second hydraulic oil cylinder 42, a first guide sleeve 411 and a first guide shaft 412 that cooperate with each other are provided on the first hydraulic oil cylinder 41, the first guide sleeve 411 is fixedly connected with the cylinder of the first hydraulic oil cylinder 41, the first guide shaft 412 is connected with the drive shaft of the first hydraulic cylinder 41, and the first guide shaft 412 is synchronously moved with the drive shaft of the first hydraulic oil cylinder 41. In addition, a second guide sleeve 421 and a second guide shaft 422 that cooperate with each other are provided on the second hydraulic oil cylinder 42, the second guide sleeve 421 is fixedly connected with the cylinder of the second hydraulic oil cylinder 42, the second guide shaft 422 is connected with the drive shaft of the second hydraulic cylinder 42, and the second guide shaft 422 is synchronously moved with the drive shaft of the second hydraulic oil cylinder 42.

The mobile vehicle maintenance station further includes a control device (not shown in figures). The control device is disposed in the compartment 10, and the mobile unfolding device and the lifting drive device are both electrically connected with the control device. The mobile vehicle maintenance station further includes a hydraulic oil cylinder, and the control device controls the mobile unfolding device and the lifting drive device to uniformly supply the hydraulic oil from the hydraulic oil cylinder to generate hydraulic power, that is, when the control device controls the first hydraulic oil cylinder 41, the second hydraulic oil cylinder 42, and the third hydraulic oil cylinder 44 to start working, the first hydraulic oil cylinder 41, the second hydraulic oil cylinder 42, and the third hydraulic oil cylinder 44 are uniformly supplied with oil from the hydraulic cylinder to provide hydraulic power, and the hydraulic driving member 25 for driving the first lift arm 22 and the second lift arm 23 is also supplied with oil by the hydraulic oil cylinder to provide hydraulic power.

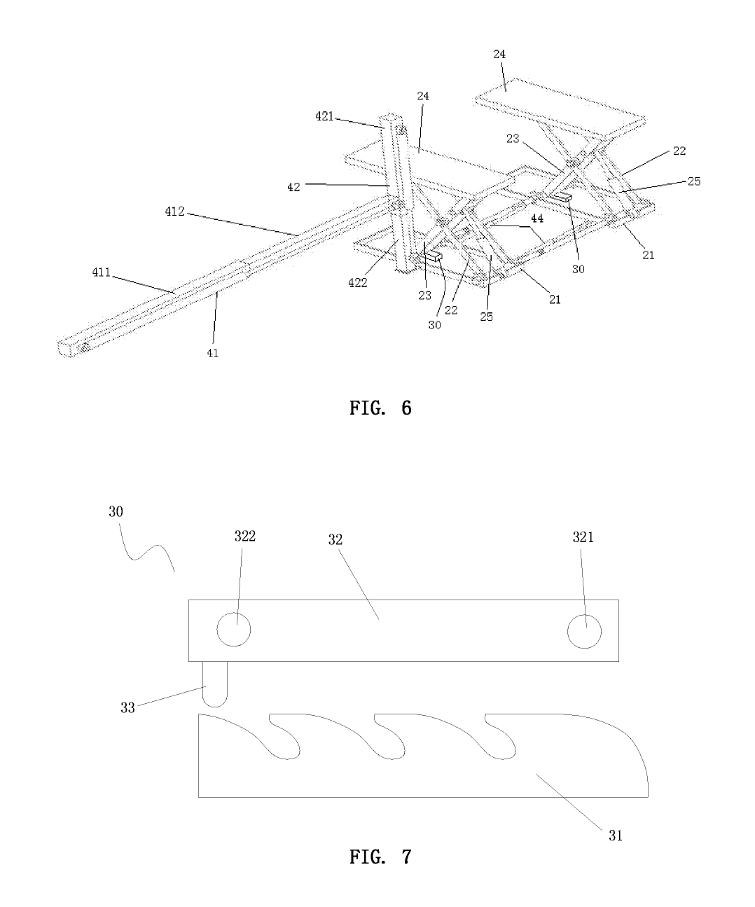

Referring to FIGS. 6 to 8, the mobile vehicle maintenance station in the first embodiment further includes a protection device 30 disposed between the base 21 and the lifting drive device, and the protection device 30 is electrically connected with the control device. In this embodiment, the protection device 30 includes a fixed protection portion 31, a snap-fit protection portion 32 and a jack-up portion 33, and the jack-up portion 33 is activated or closed in synchronization with the hydraulic drive member 25. The fixed protection portion 31 is fixedly disposed on the base 21 (the fixed protection portion 31 may be welded on the base 21), the snap-fit protection portion 32 is movably connected to the first lift arm 22 of the lifting drive device, and the jack-up portion 33 is disposed on the snap-fit protection portion 32, wherein the jack-up portion 33 is a driving cylinder, and the telescopic driving end of the driving cylinder extends beyond the snap-fit protection portion 32 and abuts against the base 21. The snap-fit protection portion 32 has two opposite connecting plates, the first ends of the two connecting plates are hingedly connected to the first lift arm 22 via a hinge shaft 321, the second ends of the two connecting plates are fixedly connected to each other via a snap-fit lever 322, and the fixed protection portion 31 is provided with a plurality of spaced snap-fit openings. After the lifting drive device raises the lifting plate 24, the protection device 30 automatically performs a protection function to prevent the lifting drive device from lowering the lifting plate 24 due to pressure relief. In this embodiment, the snap-fit slots in the fixed protection portion 31 extend in an oblique direction that coincides with the moving direction of the jack-up portion 33 when the vehicle is raised, so that the snap-fit lever 322 of the snap-fit protection portion 32 can reach into the snap-fit slot 322 of the fixed protection portion 31, that is, the snap-fit lever 322 automatically drops into the corresponding snap-fit opening to form a mutual engagement to thereby limit the lifted first lift arm 22 and second lift arm 23, thus the protection device realizes a protection function for the first lift arm 22 and the second lift arm 23, and at this time, the telescopic driving end of the jack-up portion 33 is in an initial retracted state. During the process in which the control device controls the lifting drive device to release pressure and lowers the lifting plate 24, the control device controls the protection function of the protection device 30 to be disabled. The control device is electrically connected to the jack-up portion 33, and the control device controls the telescopic driving end of the jack-up portion 33 to extend. Thus the telescopic driving end ejects the snap-fit lever 322 from the snap-fit opening, and at this time the control device controls the hydraulic drive member 25 to drive the first lift arm 22 and the second lift arm 23 to descend to lower the lifting plate 24, in this way the vehicle to be maintained can be removed from the lifting mechanism 20 and returned to the ground after the maintenance is completed. In this embodiment, the mobile vehicle maintenance station includes an air pump 53 which is installed in the compartment 10. The air pump 53 is in communication with the jack-up portion 33 (the driving cylinder) through an air passage (not shown). In addition, the air pump 53 is electrically connected to the control device, the control device simultaneously controls the operation of the air pump 53 and the jack-up portion 33, and the air pump 53 supplies air to the jack-up portion 33 to provide pneumatic power. The lifting height of the vehicle can be adjusted according to different needs and corresponding to different snap-fit openings, so that the mobile vehicle maintenance station can adapt to different working technicians for follow-up services.

After raising the vehicle to be maintained by using the lifting mechanism 20 of the mobile vehicle maintenance station, the working technician performs various maintenance operations on the vehicle to be maintained, wherein the mobile vehicle maintenance station further includes a tire maintenance equipment. The tire maintenance equipment is installed in the compartment, and the tires of the vehicle to be maintained are maintained by using the tire maintenance equipment. Specifically, the tire maintenance equipment includes a tire demounting device and a tire dynamic balance detecting device which are respectively installed in the compartment, and the tire demounting device is used to perform a tire demounting operation of a wheel removed from the vehicle to be maintained so as to perform tire repair or tire replacement, and the tire dynamic balance detecting device is used to perform dynamic balance detection and maintenance of the wheel after completion of the tire repair or the tire replacement

Further, since the vehicle widths of different vehicles are different, in order to fit different vehicle widths of various vehicles, after the working technician stably places the two bases 21 on the ground, as shown in FIG. 6, the working technician increases the distance between the respective two lifting plates 24 by operating the driving end of the third hydraulic oil cylinder 44 in the first embodiment to continue to extend according to the vehicle width of the vehicle to be maintained to fit different vehicle widths (when the two bases 21 are just lying on the ground, the lifting plate 24 is adapted to the minimum vehicle width). In this embodiment, the base 21 connected with the second hydraulic oil cylinder 42 is provided with a guide sleeve, and the other base 21 is connected with a guide rod which is inserted in the guide sleeve. After the two bases 21 are unfolded by the third hydraulic oil cylinder 44 from the folded state to be placed on the ground, when the third hydraulic oil cylinder 44 continues to drive and extend, the guide rod extends out the guide sleeve, thereby better adjusting the distance between the two bases 21 according to the vehicle width of the vehicle. Correspondingly, during the third hydraulic oil cylinder 44 is retracted, after the guide rod is driven to retract the guide sleeve, the third hydraulic oil cylinder 44 continues to drive and contract, at which time the base 21 away from the second hydraulic oil cylinder 42 can be folded and stored.

When the working technician completes the maintenance of the vehicle, the lifting plate 24 of the vehicle lifting mechanism 20 needs to be lowered to be able to drive the vehicle down to the ground, since the jack-up portion 33 is activated or closed synchronously with the hydraulic driving member 25, when starting the hydraulic drive member 25 to release pressure to lower the vehicle, the telescopic driving end of the jack-up portion 33 is extended to disengage the snap-fit lever 322 of the snap-fit protection portion 32 from the snap-fit opening of the fixed protection portion 31, and then the hydraulic drive member 25 is controlled by the control device to perform pressure relief and the lowering. When the working technician controls the hydraulic drive member 25 through the control device, the controller also controls the jack-up portion 33 to be activated to lift the snap-fit protection portion 32 away from the snap-fit opening of the fixed protection portion 31, thereby enabling the vehicle to be lowered to the ground.

After the vehicle is driven down the lift plate 24 to complete the maintenance work, the working technician needs to re-accommodate the vehicle lifting mechanism 20 back into the compartment and depart again to the next service location. In this embodiment, as shown in FIG. 1, the mobile vehicle maintenance station further includes a horizontal storage protection sensor 43 for detecting the horizontal relative position of the second hydraulic oil cylinder 42 on the compartment 10, and the horizontal storage protection sensor 43 is installed on the compartment 10, and the horizontal storage protection sensor 43 is electrically connected to the control device. When the second hydraulic oil cylinder 42 is horizontally moved and stored to a position spaced apart from the horizontal storage protection sensor 43 by a predetermined distance, the control device controls the first hydraulic oil cylinder 41 to close to stop continuing storing the lifting mechanism 20. In the process of sequentially taking back the lifting mechanism 20 and then moving the lifting mechanism 20 into the compartment 10, since other important machine parts are also provided in the compartment 10, in order to prevent the vehicle lifting mechanism 20 from colliding with other important machine parts, the relative position of the second hydraulic oil cylinder 42 in the compartment 10 is detected by the horizontal storage protection sensor 43, when the relative distance between the second hydraulic oil cylinder 42 and the horizontal storage sensor 43 is the predetermined distance, the control device controls to stop providing the storage power, and at this time the storage is completed.

In the present embodiment, the control device in the compartment 10, various sensors, the tire demounting machine 51, the tire dynamic balancing machine 52, the air pump 53, the lighting device in the compartment 10, and the like all utilize the power supplied by the power generating device 54. Moreover, the power generating device 54 can generate power by utilizing the residual heat of the exhaust gas during the running of the vehicle, then store the power, and provide the power when used, thereby achieving energy saving and environmental protection requirements.

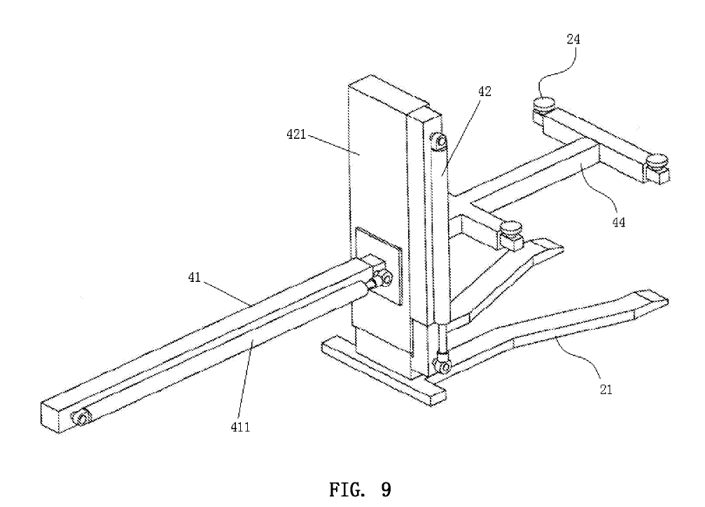

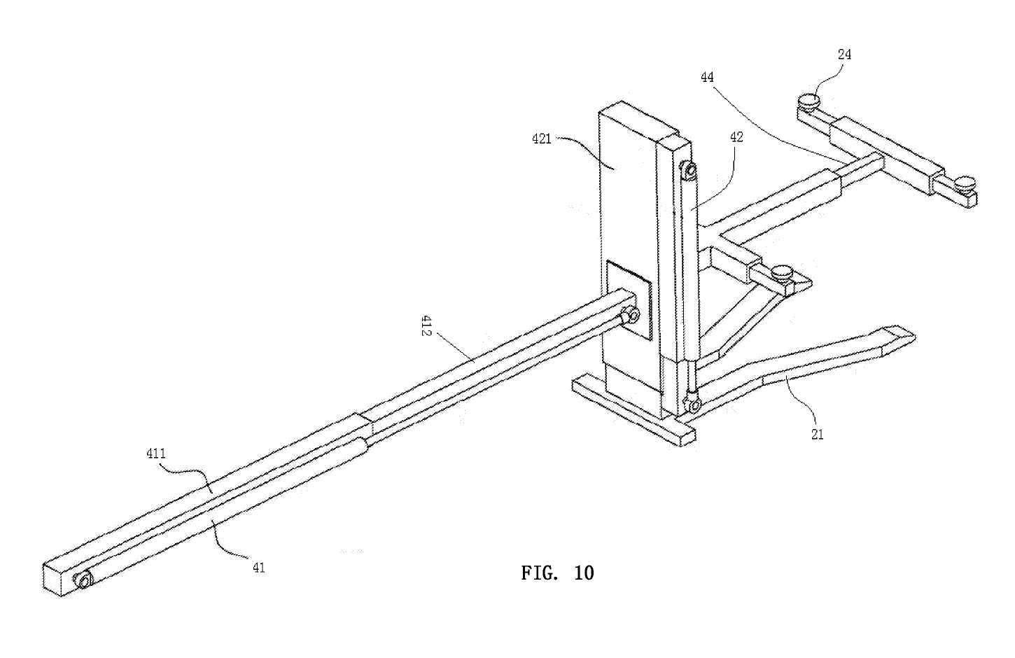

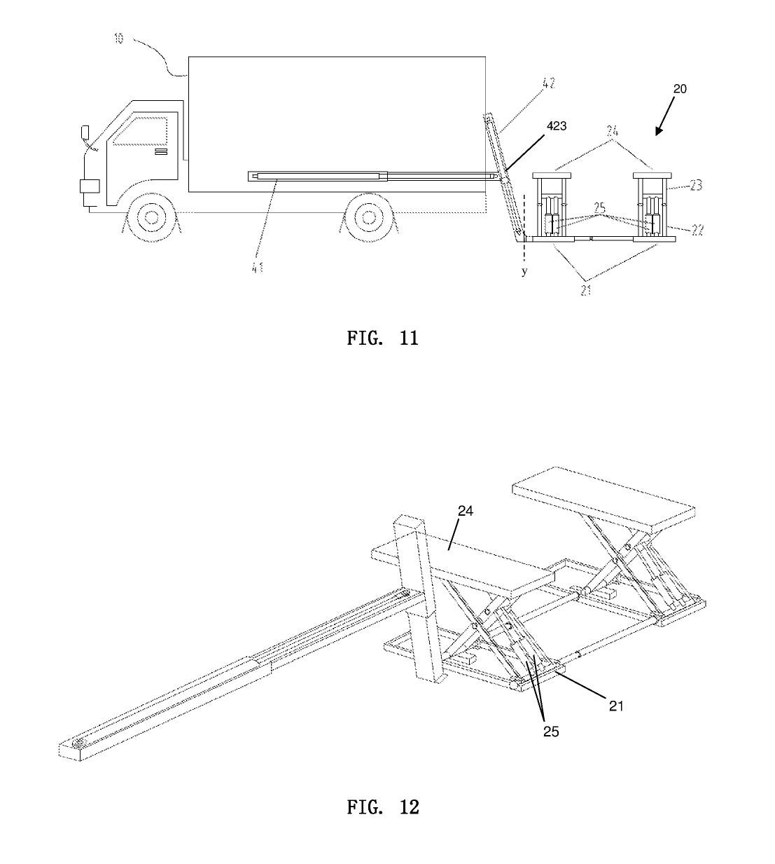

As shown in FIGS. 9 and 10, there is shown a schematic structural view of a second embodiment of the mobile vehicle maintenance station of the present application. The second embodiment has the following differences as compared with the first embodiment. In the second embodiment, the hydraulic drive member (not shown in FIGS. 9 and 10) that drives the lifting plate 24 to raise the vehicle to be maintained is connected to the second guide sleeve 421, and one end of the lifting plate 24 is connected to the driving end of the hydraulic drive member. In the second embodiment, the base 21 is a unitary base, which can maintain the stabilization and balance of the entire lifting mechanism 20. Further, the base 21 can be designed as a [symbol] -shaped fork structure, and the externally expanded [symbol] -shaped fork structure is subjected to the force of the whole lifting mechanism 20. In addition, in the second embodiment, in order to accommodate vehicles of different vehicle widths, the third hydraulic oil cylinder 44 is used to control the lifting plate 24 to be deployed in two pieces, thereby controlling the separation width of the two lifting plates 24 to adapt to different vehicle widths, at this time, one end of the third hydraulic oil cylinder 44 is fixedly connected to the lifting plate 24 adjacent to the second hydraulic oil cylinder 42, and the driving end of the third hydraulic oil cylinder 44 is connected to the other lifting plate 24 to achieve a separation distance between the lifting plates 24. Preferably, the lifting plates 24 of the second embodiment are attached to the bottom of the chassis of the vehicle to be maintained for lifting. At this time, the lifting plates 24 can be simplified to support four fulcrums of the chassis of the vehicle to be maintained. The fulcrums are connected by connecting rods, and the third hydraulic oil cylinder 44 is connected between the two connecting rods which can be separated from each other, thereby controlling the separation between the respective fulcrums to accommodate different vehicle widths. Except for the above structure, the rest of the structure is the same as that of the mobile vehicle maintenance station of the first embodiment, and details are not described herein again.

In the maintenance method for the maintenance operations of the vehicle to be maintained provided by the present application, the working technician perform mobile and follow-up maintenance operations on dispersed vehicles in various locations by carrying the mobile vehicle maintenance station provided above, thereby eliminating the delay of the vehicle owner caused by calling the trailer after the vehicle failure, and it is convenient to contact the working technician to perform the necessary vehicle maintenance, which greatly saves the owner's time and greatly satisfies the boundary requirement of the vehicle owner for the vehicle maintenance operations.

The above are only the preferred embodiments of the present application, and are not intended to limit the present application. Any modifications, equivalents, and improvements made within the spirit and scope of the present application should be included in the scope of the present application.

For example, referring to FIG. 11, according to another embodiment of the present disclosure, one end of the driving rod 423 is the driving end of the mobile unfolding device and connected to the lifting mechanism 20, and the driving rod 423 is inclined outward from the driving end with respect to the vertical direction y when the lifting mechanism 20 is placed on the ground. The inclined angle of the driving rod 423 is preferably 15 degree. By this configuration, the space for the vehicle to be maintained can be increased.

Referring to FIG. 12, according to another embodiment of the present disclosure, a pair of hydraulic drive machines 25 are connected between the base 21 and a same lifting plate 24 of the lifting mechanism. By using double hydraulic drive machines (oil cylinders for example), the lifting mechanism can lift heavier vehicles.

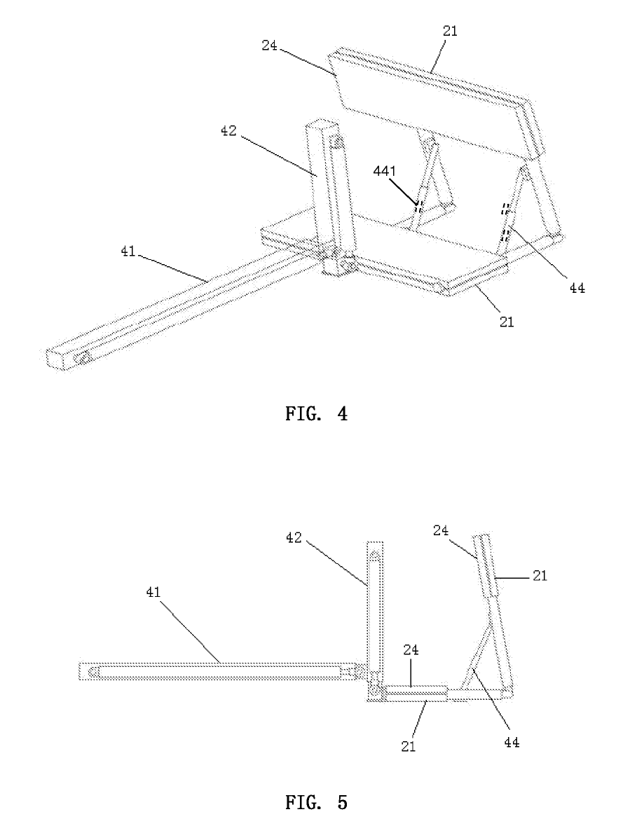

According to another embodiment of the present disclosure, the lifting mechanism includes two lifting portions that are foldable with respect to each other, a hydraulic drive member is connected between the two lifting portions, and an explosion-proof valve 441 (shown in FIG. 4) is arranged in the hydraulic drive member. Thus, double safety protection can be provided during the lifting.

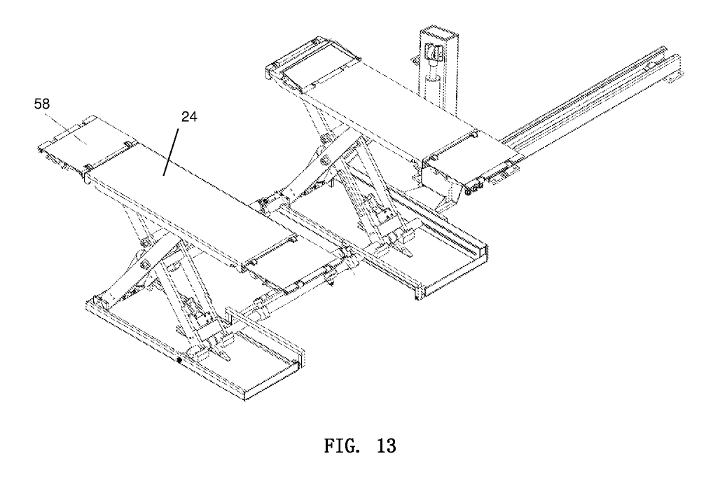

Referring to FIG. 13, according to another embodiment of the present disclosure, the lifting mechanism further includes sloping plates 58 integrally connected with each lifting plate 24. During the maintenance, it is only need to hang on the sloping plates, which is convenient to install and also easy for the vehicle to enter.

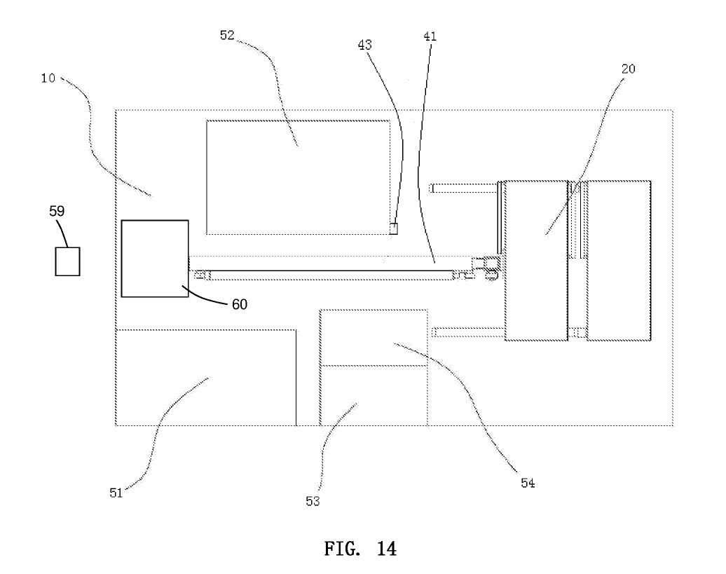

Referring to FIG. 14, according to another embodiment of the present disclosure, the control device 60 is controlled by a remote control signal sent by a wireless remote control device 59, which makes it easy for maintenance personnel to observe the equipment operation during the maintenance.

1. A vehicle maintenance method using a mobile vehicle maintenance station, comprising the following steps of:
determining a location of a vehicle to be maintained;
carrying the mobile vehicle maintenance station to the location of the vehicle to be maintained and using the mobile vehicle maintenance station to perform corresponding maintenance operations on the vehicle to be maintained;
wherein during the maintenance operations the vehicle to be maintained is raised by using a lifting mechanism of the mobile vehicle maintenance station and the corresponding maintenance operations are performed, and the maintenance operations include the following steps of:
taking the lifting mechanism out of a compartment of the mobile vehicle maintenance station and supporting the lifting mechanism on the ground;
moving the vehicle to be maintained on the lifting mechanism and fixing the same thereto; and
raising the vehicle to be maintained to a predetermined height by using the lifting mechanism so that an overhead space for the maintenance operations is formed between a chassis of the vehicle to be maintained and the ground, which allows the entering of a working technician for operation.

2. The vehicle maintenance method using a mobile vehicle maintenance station according to claim 1, wherein the mobile vehicle maintenance station comprises a mobile unfolding device fixedly installed in the compartment, a driving end of the mobile unfolding device is connected with the lifting mechanism, during the maintenance operations taking the lifting mechanism out of the compartment of the mobile vehicle maintenance station is by using the mobile unfolding device taking the lifting mechanism out of the compartment and lowering the lifting mechanism from the height of the floor of the compartment to the ground.

3. The vehicle maintenance method using a mobile vehicle maintenance station according to claim 2, wherein the mobile vehicle maintenance station further comprises a tire maintenance equipment installed in the compartment, and the maintenance operations further comprise the step of: by using the tire maintenance equipment performing maintenance operations on a tire of the vehicle to be maintained.

4. The vehicle maintenance method using a mobile vehicle maintenance station according to claim 3, wherein the tire maintenance equipment comprises a tire demounting device and a tire dynamic balance detecting device respectively installed in the compartment, the maintenance operations further include the step of: by using the tire demounting device, performing a tire demounting operation of a wheel removed from the vehicle to be maintained so as to perform tire repair or tire replacement, and by using the tire dynamic balance detecting device performing dynamic balance detection and maintenance of the wheel after completion of the tire repair or the tire replacement.

5. The vehicle maintenance method using a mobile vehicle maintenance station according to claim 2, wherein the lifting mechanism comprises a base, a lifting drive device and a lifting plate, the base is connected with the driving end of the mobile unfolding device, one end of the lifting drive device is connected to the base, the other end of the lifting drive device is connected with the lifting plate, the base is placed on the ground for providing support, and the vehicle to be maintained is moved on the lifting plate and fixed, and during the process of raising the vehicle to be maintained to the predetermined height by using the lifting mechanism, the lifting plate is driven by the lifting drive device to be raised so as to form an overhead space for the maintenance operations by the chassis of the vehicle to be maintained and the ground.

6. The vehicle maintenance method using a mobile vehicle maintenance station according to claim 5, wherein the mobile vehicle maintenance station further comprises a control device disposed in the compartment, the mobile unfolding device and the lifting drive device are both electrically connected with the control device, both the mobile unfolding device and the lifting drive device are hydraulic drive machines, the mobile vehicle maintenance station further comprises a hydraulic oil cylinder, and the control device controls the mobile unfolding device and the lifting drive device to uniformly supply the hydraulic oil from the hydraulic oil cylinder to generate hydraulic power.

7. The vehicle maintenance method using a mobile vehicle maintenance station according to claim 6, wherein the mobile vehicle maintenance station further comprises a protection device disposed between the base and the lifting drive device, the protection device is electrically connected with the control device; during the process of raising the vehicle to be maintained to the predetermined height by using the lifting mechanism so as to form an overhead space for the maintenance operations between the chassis of the vehicle to be maintained and the ground, after the lifting drive device raises the lifting plate the protection device automatically implements protection function to prevent the lifting drive device from falling due to pressure relief, and during the process of controlling the lifting drive device to release pressure to lower the lifting plate the control device controls the protection function of the protection device to be disabled.

8. The vehicle maintenance method using a mobile vehicle maintenance station according to claim 7, wherein the protection device comprises a fixed protection portion, a snap-fit protection portion and a jack-up portion, the fixed protection portion is fixedly disposed on the base, the snap-fit protection portion is movably connected to the lifting drive device, and the jack-up portion is disposed on the snap-fit protection portion; during the process of raising the vehicle to be maintained to the predetermined height by using the lifting mechanism so as to form an overhead space for the maintenance operations between the chassis of the vehicle to be maintained and the ground, after the lifting drive device raises the lifting plate, the snap-fit protection portion and the fixed protection portion automatically cooperate to implement the protection function to prevent the lifting drive device from falling due to pressure relief, and during the process in which the control device controls the lifting drive device to release pressure to lower the lifting plate, a driving end of the jack-up portion pushes up the snap-fit protection portion to disable the protection function formed between the snap-fit protection portion and the fixed protection portion.

9. The vehicle maintenance method using a mobile vehicle maintenance station according to claim 8, wherein the jack-up portion is a pneumatic machine, the mobile maintenance station further comprises an air pump, the air pump and the pneumatic machine are connected through an air pipeline to pump the air, air pressure is supplied to the pneumatic machine so that a driving end of the pneumatic machine pushes up the snap-fit protection portion, the air pump is electrically connected with the control device, and the control device controls the operation of the air pump to supply air pressure to the pneumatic machine.

10. The vehicle maintenance method using a mobile vehicle maintenance station according to claim 1, wherein the mobile vehicle protection station further comprises a separate power source disposed in the compartment to provide required power during the maintenance operations.

11. A mobile vehicle maintenance station, comprising:
a compartment;
a lifting mechanism for raising a vehicle to be maintained; and
a mobile unfolding device fixedly installed in the compartment, a driving end of the mobile unfolding device is connected with the lifting mechanism to take the lifting mechanism out of the compartment and lower the lifting mechanism from the height of the floor of the compartment to the ground.

12. The mobile vehicle maintenance station of claim 11, further comprising a tire maintenance equipment installed in the compartment.

13. The mobile vehicle maintenance station according to claim 12, wherein the tire maintenance equipment comprises a tire demounting device and a tire dynamic balance detecting device respectively installed in the compartment.

14. The mobile vehicle maintenance station according to claim 11, wherein the lifting mechanism comprises a base, a lifting drive device and a lifting plate, the base is connected with the driving end of the mobile unfolding device, one end of the lifting drive device is connected to the base, the other end of the lifting drive device is connected with the lifting plate, the base is placed on the ground for providing support.

15. The mobile vehicle maintenance station according to claim 14, further comprises a control device disposed in the compartment, the mobile unfolding device and the lifting drive device are both electrically connected with the control device, both the mobile unfolding device and the lifting drive device are hydraulic drive machines, the mobile vehicle maintenance station further comprises a hydraulic oil cylinder, and the control device controls the mobile unfolding device and the lifting drive device to uniformly supply the hydraulic oil from the hydraulic oil cylinder to generate hydraulic power.

16. The mobile vehicle maintenance station according to claim 14, wherein the mobile unfolding device includes a driving rod, one end of the driving rod is the driving end of the mobile unfolding device and connected to the lifting mechanism, and the driving rod is inclined outward from the driving end with respect to the vertical direction when the lifting mechanism is placed on the ground.

17. The mobile vehicle maintenance station according to claim 14, wherein the lifting mechanism further includes a pair of hydraulic drive machines connected between the base and a same lifting plate.

18. The mobile vehicle maintenance station according to claim 14, wherein the lifting mechanism further includes two lifting portions that are foldable with respect to each other, a hydraulic drive member is connected between the two lifting portions, and an explosion-proof valve is arranged in the hydraulic drive member.

19. The mobile vehicle maintenance station according to claim 14, wherein the lifting mechanism further includes a sloping plate integrally connected with the lifting plate.

20. The mobile vehicle maintenance station according to claim 15, wherein the control device is controlled by a remote control signal sent by a wireless remote control device.
